(19) United States
(12) Patent Application Publication
(10) Pub. No.: US 2002/0042041 A1
(43) Pub. Date: Apr. 11, 2002

(54) Systems and methods for organizing data relationships

(76) Inventors: Terry S. Owens, Orem, UT (US); Donald J. West, Orem, UT (US); Douglas C. Draper, Provo, UT (US); Duane R. Winden, Provo, UT (US); William M. Bancroft, Provo, UT (US)

Correspondence Address: KIRTON & McCONKIE, Suite1800, 60 East South Temple, Salt Lake City, UT, 84111, US

(21) Appl. No.: 09/988,103

(22) Filed: Nov. 13, 2001

Related U.S. Application Data
(63) Continuation-in-part of application No. 08/781,102, filed on Jan. 9, 1997.
Application No. 08/781,102 is a continuation of application No. 08/548,751, filed on Oct. 26, 1995, now abandoned.
Application No. 08/548,751 is a division of application No. 08/408,734, filed on Mar. 22, 1995, now abandoned.

(51) Int. Cl. G09B 3/00

(52) U.S. Cl. 434/322

(57) ABSTRACT

Systems and methods for creating and using a cognitive index, selectively providing objects from the index, and organizing information to generate questions contextually relevant to the information associated with the index. A computer device is used to create a cognitive index that includes various objects and/or information that may be selectively related. The index further includes one or more conceptual nodes that may be related to one or more associated nodes through one or more expressions. Each associated node may include objects and/or information relating thereto, which may be selectively and/or automatically provided from the index. The objects and/or information associated with the index may be used to provide information requested and/or to generate questions contextually relevant to the information associated with the index.

### RELATED APPLICATIONS

This application claims priority to U. S. patent application Ser. No. 09/286,527, filed Apr. 5, 1999, entitled “METHOD AND SYSTEM FOR COMPUTERIZED AUTHORING, LEARNING, AND EVALUATION,” which is a continuation-in-part application of U.S. patent application Ser. No. 08/781,102, filed Jan. 9, 1997, now issued as U.S. Pat. No. 5,890,911, entitled “METHOD AND SYSTEM FOR COMPUTERIZED LEARNING RESPONSE AND EVALUATION,” which is a continuation application of U.S. patent application Ser. No. 08/548,751 filed Oct. 26, 1995, now abandoned, entitled “METHOD AND SYSTEM FOR COMPUTERIZED LEARNING RESPONSE AND EVALUATION,” which is a divisional application of U.S. patent application Ser. No. 08/408,734 filed Mar. 22, 1995, entitled “METHOD AND SYSTEM FOR COMPUTERIZED LEARNING RESPONSE AND EVALUATION,” now abandoned.

### BACKGROUND OF THE INVENTION

1. Field of the Invention

The present invention relates to organizing data relationships. In particular, the present invention relates to systems and methods for creating and using a cognitive index, selectively providing objects from the index, and organizing information to generate questions contextually relevant to the information associated with the index.

2. Background and Related Art

Typically, the process of testing holds a central role in the learning process. For example, in an educational setting an individual is first presented with information that is to be learned. The test is subsequently given in order to measure the amount of information learned by the individual. Testing has evolved into a specialized field. Many theories have been developed in order to both develop tests designed to measure a particular level of achievement or mastery and to interpret the results of such a test. Thus, standardized tests have been developed to measure intelligence quotient (“I.Q.”), personality traits, fitness to practice a profession (e.g., law, medicine, construction, accounting, etc.), aptitude for success in a specific environment, and the mastery of individual skills.

Historically, tests have been administrated on either an individual basis (e.g., an oral examination) or on a group basis (e.g., a test administered in an educational setting where students record their answers on paper that will be evaluated at a later time). One of the advantages of a written test is the efficiency in testing a large number of individuals. However, a written test typically lacks the ability to provide immediate feedback on an individual basis. Thus, it is generally recognized that traditional testing represents a tradeoff between efficiency of grading and the ability to provide individual feedback.

It is generally unreasonable to expect that an individual test would be developed for each individual. Thus, in order to preserve the ability of the test to measure an individual's aptitude, care must be taken not to disclose the answers for a particular test. Likewise, where the test is designed to measure individual performance, care must be taken by the administrator to ensure that each individual takes the test based upon on the individual's own knowledge.

In order to prevent cheating and to minimize the probability of an individual test score being influenced by others, multiple tests may be developed and simultaneously administered to in effect cause the individuals sitting near each other to take a different test. However, problems associated with this method may prevent its implementation because of the effort and expense of developing and grading multiple tests.

The measurement of performance and feedback are critical in the learning process. While written tests may be an efficient way to measure performance, the tests are largely inefficient in providing adequate feedback for learning. Generally there is a large lag time between the time when the test is taken and when the results of the test are returned. During this lag time, new information is usually presented. Thus, when the tests are returned, the focus of both the material and the individual has shifted. Thus, few students will use such a test to evaluate their weaknesses and return to prior material in order to strengthen those weaknesses.

In order to overcome this limitation, some courses of study are structured with many smaller tests interspersed throughout the material. While this generally improves the potential for feedback, such a method is relatively inefficient. Further, it dramatically increases the workload of an instructor, teacher, or administrator.

In order to enhance the learning environment, many educators realize that the optimal form of instruction would be a personalized instructor for each student or individual. This, however, is impractical in most learning environments. In order to provide a better learning environment that more closely approaches the ideal environment of one instructor for every student, some educators are turning to computers. Through the use of computers, learning programs may be developed that provide instruction and feedback virtually simultaneously.

For example, one advantage of the use of computers in testing is that a general course of instruction may be presented to an individual. The computer may then query the individual regarding the principles learned, tally a score for the individual, and provide the score to the individual. This allows the individual to return to information not learned and again review the material. Another advantage of computers is that they allow the pace of instruction to be varied according to the ability of the individual to learn. Furthermore, computers may be used to enhance personal learning outside the traditional educational environment.

Computer programs currently designed to aid in the learning process first present a section of information and then test the individual based on the information presented. The structures of these programs are generally organized in a pre-set or pre-defined manner. Thus, like textbooks typically utilized in traditional educational settings, the program presents a chapter of information and then quizzes the user on the information contained in that chapter. The next chapter is then presented along with the associated test. Programs that are organized to present information in this manner, are generally very inflexible and do not allow the user to determine in which order the information will be presented. Although this has the advantage of presenting information in an order that has been shown by long experience to be the “best” for learning the information, it forces the user to review information that may already be known.

In order to provide more flexibility, some programs allow the user to select the chapters that will be presented. Thus, the user is allowed to determine the basic ordering of the chapters of information. While this allows the user some degree of flexibility in the process, it still deals with information in relatively large units. Thus, the presentation of information still remains relatively fixed and ridged. Concepts from different units or chapters must be tied together in the mind of the user. Similarly, because the tests are presented after each unit, no overview test is provided.

In an attempt to remedy this shortcoming, some programs are also provided with a global or overview test. These tests allow a user to be tested on the entire subject matter. Because of the general nature of these tests, a user must generally review all material in the program before these tests may be utilized. Thus, there still remains an inability to test only on the information that has been presented to a user.

Another potential problem with these types of programs is the inability of the program to vary its behavior when presenting test questions. Once an individual has worked through a lesson or chapter, the set of questions at the end are generally fixed. Thus, an individual who must review the material several times in order to learn it, may learn the sequence of test questions. The test then becomes less a measure of the actual knowledge possessed by the user and more a measure of the ability of the user to memorize the sequence and order of test questions. In order to prevent this occurrence, many traditional programs include a random component. This component presents the test questions in a random order. Memorization of the test questions by an individual is thus more difficult. While this has the advantage of providing a little different look each time the program is run, it still does not totally solve the problem.

In an attempt to strengthen this part of the program, certain manufactures have created a larger set of questions. The test would then ask a subset of these questions in a random order. In this way, not only is the order of test questions randomized, but also the selection of the test questions themselves. Thus, a user reviewing the same material on two different occasions may not be presented with the same questions. While this provides an even greater degree of randomness so that the tests are different each time they are taken, care must be utilized to insure that each question is asked only once. Furthermore, the effectiveness of this method depends on the number of questions available for use relative to the number of questions that are asked during each test.

This problem raises one of the limitations of these types of programs. The effectiveness of the test and evaluation section of the program is generally dependent on the number of questions that may be asked of an individual. During development of these programs, it is often very difficult and time consuming for an individual to generate a pool of questions for use during testing. Each question must be authored and then entered and programmed into the computer so that it can be asked at the appropriate time. The larger the number of test questions, the harder the program is to develop. Thus, many of these types of programs utilize relatively simple testing methodologies in order to minimize the total number of test questions that must be developed.

Speed and complexity of development are always paramount considerations when crafting these types of learning programs. Development of these types of programs generally begins by obtaining information. After information is obtained, the information must be sorted into logical categories for presentation. This process may be illustrated by a glance through a typical classroom textbook. In the textbook, information is organized or grouped by chapters to provide a logical and coherent flow for the individual utilizing the textbook. In much the same way, information is organized and structured into chapters or units or lessons to facilitate this logical and orderly flow. For each chapter or lesson, if testing is desired, then a pool of test questions must be drafted and developed. The answers to these questions must also be developed. The programmer or developer then organizes the information so that it may be presented to the user. The test questions and answers are also organized so they may be presented to the user.

The time it takes to develop a learning program may be very significant. In order to minimize the development time, there is a tendency to minimize either the amount of information presented or the number of test questions presented. This, however, may not be acceptable since the resulting product is insufficient to present the depth or breadth of the information required. For example, only questions dealing with the narrow range of presented information may be asked. The student is not presented with a broad enough spectrum of information to allow the answering of analogous rather than specific questions.

Current methods do not include a satisfactory method of reducing development time. In an attempt to reduce the effort required to develop test questions, authoring tools have been implemented that provide for the automatic generation of questions related to the lesson material authored. One such method is found in U.S. Pat. No. 5,797,753, issued Aug. 25, 1998, which describes an authoring tool that allows the program to automatically generate question sets to evaluate a learner's review of a subject matter. Unfortunately, the question sets, although designed to be objective in evaluating the information learned by the student, suffer several weaknesses.

The first weakness is that the content of the material presented to the student is not placed in any type of contextual relation. The lack of contextual relation may turn the experiment merely into a rote learning experience for the student without any logical connection to the overall subject matter of the given topic. Contextual relationships typically pull together the subject matter in a satisfying and useful whole for the student to understand.

Another disadvantage involves the question set generation of a right answer and various wrong answers. The authoring tool typically has no problem generating the correct right answer associated with the generated question, however the wrong answers provided as distractors are typically selected arbitrarily from the resource material presented to the student without consideration to the context of the question asked. Since the distractors are arbitrarily selected, they do not always have a contextual relation to the question and thus may be eliminated rather quickly by the individual as being irrelevant. Accordingly, if all of the distractors are selected in such a fashion, then only the right answer would have any sense of relation to the question generated and no fair evaluation of the student's true understanding of the subject matter is achieved.

Another disadvantage of the evaluation system is that without the contextual relationships of the underlying subject matter, the author is at the mercy of the question generation portion to generate question sets that may provide a fair evaluation of the underlying subject matter. As the question sets are typically generated in an arbitrary fashion, it is not always possible to provide specific questions that are necessary to test the student's actual understanding of critical subject matter within the given lesson as required by the author/instructor. In other words, the tests are not standard or fair in evaluating similar understanding between the different students, since the test questions are typically too random to provide such results.

Thus, while some authoring tools currently exist, no current tools or traditional method satisfactorily develop the desired results nor adequately reduce development time. The traditional tools are generally structured so as to minimize the effort involved in presenting information to the user, but traditional test questions and testing methods must still be developed through a very laborious process. Thus, it would be an advancement in the art to provide a method that reduces the effort required to develop test questions and provides the desired results for the testing purposes.

### SUMMARY OF THE INVENTION

The present invention relates to organizing data relationships. In particular, the present invention relates to systems and methods for creating and using a cognitive index, selectively providing objects from the index, and organizing information to generate questions contextually relevant to the information associated with the index.

Implementation of the present invention takes place in association with a computer device that may be used to create a cognitive index. The index includes various objects and/or information that may be selectively related. The index includes one or more conceptual nodes that may be related to one or more associated nodes through one or more expressions. Each associated node may include objects and/or information relating thereto that may be selectively and/or automatically provided from the index. The objects and/or information associated with the index may be organized to generate questions contextually relevant to the information associated with the index.

While the methods and processes of the present invention have proven to be particularly useful in the area of educational testing and/or learning, those skilled in the art can appreciate that the methods and processes can be used in a variety of different applications and in a variety of different areas of manufacture to yield desired results.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates an example of a networked environment of the representative system of FIG. 1;

FIG. 3 illustrates a flow chart that provides a representative embodiment for creating a cognitive index in accordance with the present invention;

FIG. 4 illustrates a representative relationship established between a conceptual node and one or more associated nodes in accordance with the present invention;

FIG. 5 illustrates a flow chart that provides a representative embodiment for providing objects from the conceptual index in accordance with the present invention;

FIG. 6 illustrates a representative structural diagram of the presentation portion of a representative system in accordance with the present invention;

FIG. 7 illustrates a representative graphical user interface image of selected fields utilized within the database to provide context relation in accordance with the present invention;

FIG. 8 illustrates a representative graphical user interface image of defining an object with an associated concept as well as providing placement of the object within the lesson in accordance with the present invention;

FIG. 9 illustrates a representative graphical user interface image of defining object relations for question generation and indexing in accordance with the present invention;

FIG. 10 illustrates a representative graphical user interface image of defining an object with an associated concept as well as providing placement of the object within the lesson in accordance with the present invention;

FIG. 11 illustrates a representative graphical user interface image similar to FIG. 10 of defining an object with an associated concept as well as providing placement of the object within the lesson in accordance with the present invention;

FIG. 12 illustrates a flow chart that provides a representative embodiment for executing available options in the presentation portion;

FIG. 13 illustrates a representative graphical user interface image of a concept outline utilized for question generation and nascent indexing in accordance with the present invention;

FIG. 14 illustrates a representative graphical user interface image depicting a question based on a concept item placed within a template format in accordance with the present invention;

FIG. 15 illustrates a representative graphical user interface image depicting the question parts utilized in FIG. 14;

FIG. 16 illustrates a representative a graphical user interface image depicting the general question outline procedure for generating questions in accordance with the present invention;

FIG. 17 illustrates a representative graphical user interface image of a sample question generated and displayed in accordance with the present invention;

FIG. 18 illustrates a representative structural diagram of the presentation portion of the system in accordance with present invention;

FIG. 19 illustrates a representative structural diagram of a page layout and various relationships utilized within the present invention; and

FIG. 20 illustrates a flow chart that provides a representative embodiment demonstrates how the question generation procedure may be performed in either the authoring portion or the presentation portion of the present invention.

### DETAILED DESCRIPTION OF THE INVENTION

The present invention relates to organizing data relationships. In particular, the present invention relates to systems and methods for creating and using a cognitive index, selectively providing objects from the index, and organizing information to generate questions contextually relevant to the information associated with the index.

Embodiments of the present invention take place in association with a computer device that may be used to create a cognitive index. The index includes various objects and/or information that may be selectively related. The index includes one or more conceptual nodes that may be related to one or more associated nodes through one or more expressions. Each associated node may include objects and/or information relating thereto that may be selectively and/or automatically provided from the index. The objects and/or information associated with the index may be organized to generate questions contextually relevant to the information associated with the index.

In the disclosure and in the claims the term “anchor” shall refer to a bookmark, link, note, or indication that refers to a particular location, file, object, or piece of information. Furthermore, in the disclosure and in the claims, the term “node” shall refer to an object or piece of information that may be associated with another object or piece of information. Examples of nodes include a conceptual node and an associated node, wherein the associated node relates in some fashion t the conceptual node, as will be further discussed below. Also, in the disclosure and in the claims, the term “object” shall refer to any type of information that may be processed on an electronic medium, including text, sound, graphics, video, and any other data, file or information.

The following disclosure of the present invention is grouped into three subheadings, namely “Exemplary Operating Environment,” “Creating and Using a Cognitive Index,” and “Computer Authoring, Learning, and Evaluation.” The utilization of the subheadings is for convenience of the reader only and is not to be construed as limiting in any sense.

### Exemplary Operating Environment

Embodiments of the present invention embrace the use of a computer device to create and/or utilize a cognitive index. The index may be used to provide objects and/or information from the index, and organize the object and/or information to generate questions contextually relevant to the information associated with the index.

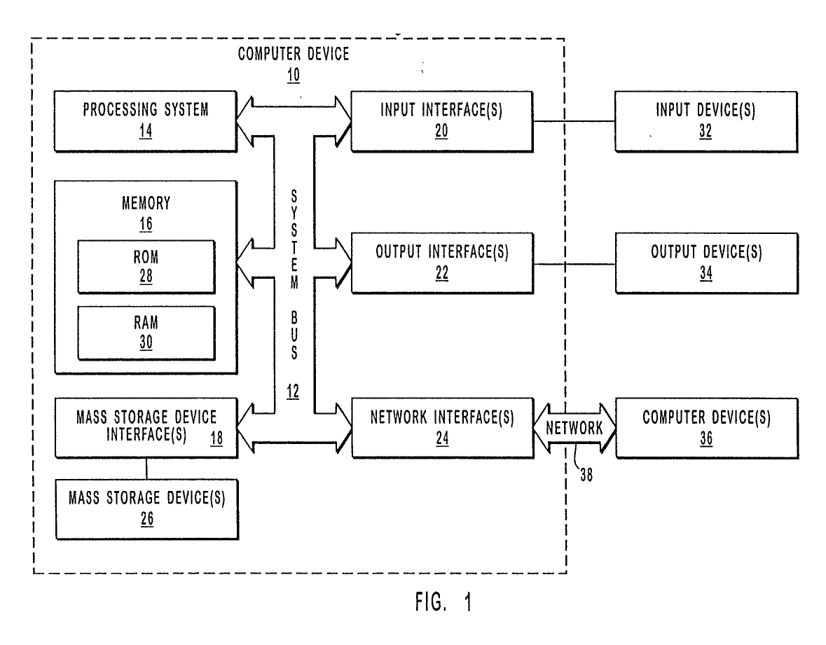

FIG. 1 and the corresponding discussion are intended to provide a general description of a computer device as a suitable operating environment to create and/or utilize a cognitive index. One skilled in the art will appreciate that the invention may be practiced by one or more computing devices and in a variety of system configurations, including in a networked configuration.

Embodiments of the present invention embrace one or more computer readable media that may be used to create and/or utilize a cognitive index, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CDROM”), or any other device or component that is capable of providing data or executable instructions that may be accessed by a processing system.

With reference to FIG. 1, a representative system for creating and/or utilizing a cognitive index includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

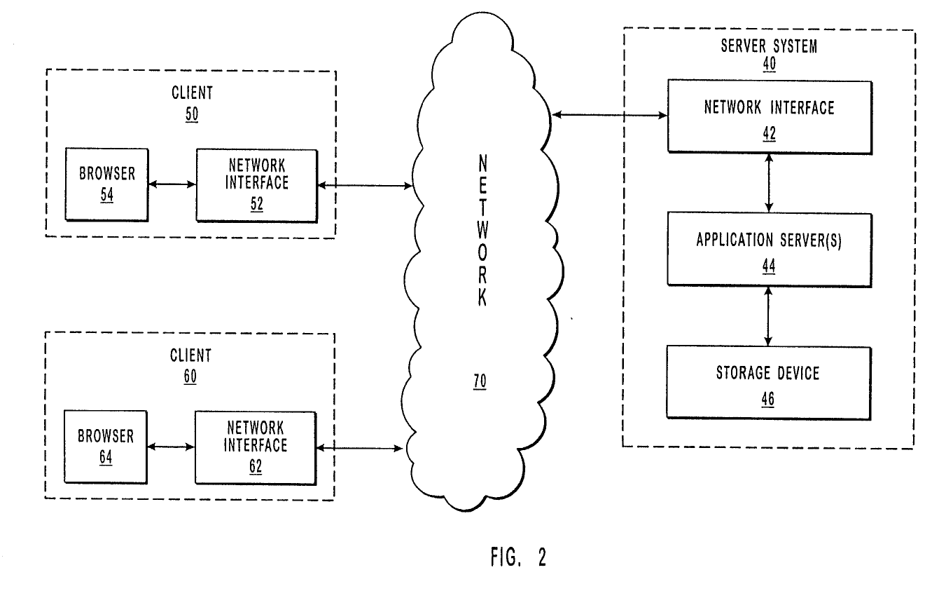

While those skilled in the art will appreciate that the invention may be practiced in networked computing environments with many types of computer system configurations, FIG. 2 represents an embodiment of the present invention that enables one or more client computer devices to be used to create and/or use one or more cognitive indices. While FIG. 2 illustrates an embodiment that includes two clients connected to the network, alternative embodiments include one client connected to a network or many clients connected to a network. Moreover, embodiments in accordance with the present invention also include a multitude of clients throughout the world connected to a network, where the network is a wide area network, such as the Internet.

In FIG. 2, server system 40 represents a system configuration that includes one or more servers that are used in creating and/or using a cognitive index. By way of example, server system 40 may be a single server in cases where a single server can process and preserve the entire amount of information required to perform the methods and systems of the present invention, as will be further explained below. Alternatively, server system 40 may be a conglomeration of servers that process and preserve a high volume of information.

The emergence of the Internet has enabled a very large number of computer devices across the world to be connected across a wide area network in order to participate in the utilization or exchange of information. The following is a discussion of an embodiment of the present invention that includes a plurality of clients, illustrated as clients 50 and 60, that are connected to server system 40 across the Internet, illustrated as network 70, in order to create and/or utilize one or more cognitive indices.

With reference to FIG. 2, clients 50 and 60 each include a network interface (respectively illustrated as network interfaces 52 and 62) and a Web Browser (respectively illustrated as browsers 54 and 64). Network interface 52 is a communication mechanism that allows a client, such as client 50 to communicate to server system 40 by a network 70, such as the Internet. Browser 54 is an application program that allows information to be displayed on a monitor device as text and/or graphics in the form of a web page. A browser allows for the entering of uniform resource locator (“URL”) to thereby access the corresponding web page. Therefore, clients 50 and 60 may independently access a particular web page that may be used in the creation and/or utilization of a cognitive index.

Server system 40 includes network interface 42, application servers 44, and storage device 46. Network interface 42 is a communication mechanism that allows server system 40 to communicate with one or more clients by a network 70. Application servers 44 include one or more servers for processing and/or preserving information, and may be employed for providing and maintaining a web page that enables the creation and/or utilization of a cognitive index. Storage device 46 includes one or more storage devices for preserving information, such as data, objects and/or other information to perform the methods enclosed herein. Storage device 46 may be internal or external to application servers 44.

Thus, a user or program at one of the clients, such as client 50, may access a web page maintained by one or more of the application servers 44 and electronically create and/or utilize a cognitive index. While the discussion above has presented a representative system configuration for implementing the present invention, those skilled in the art will appreciate that the methods of the present invention and processes thereof may be implemented in a variety of different system configurations.

### Creating and Using a Cognitive Index

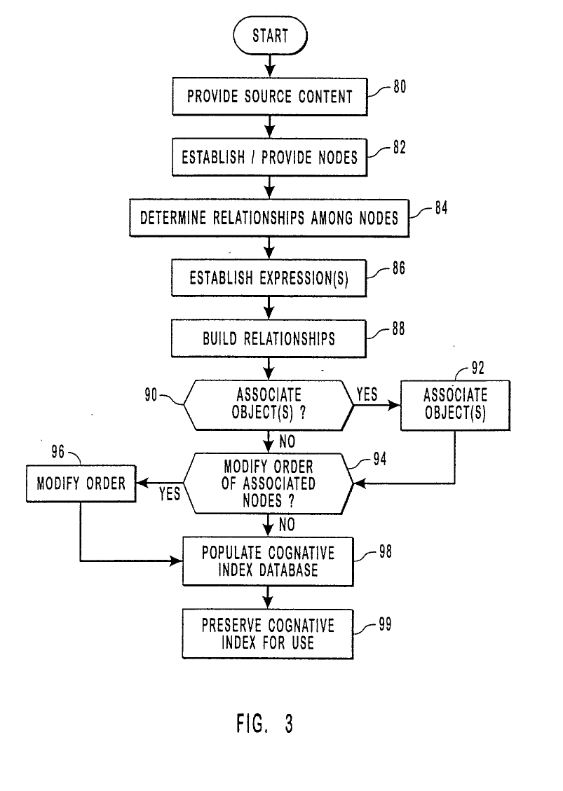

As provided above, embodiments of the present invention embrace the creation and/or utilization of one or more cognitive indices. With reference to FIG. 3, an example for creating a cognitive index is provided. In FIG. 3 execution begins at step 80 where a source content is provided. The source content may be a text file or other electronic information that may be utilized in the creation of a cognitive index. At step 82, one or more nodes are established or otherwise provided. The nodes may be established by inputting information directly or by identifying or establishing anchors or bookmarks within the source content. Execution then proceeds to step 84, where a relationship among the various nodes is determined. The relationship may include any reason for interconnecting or otherwise associating two ore more nodes. Such relationships may include time and space relations, objective assignment of meaning relations, subjective assignment of meaning relations, planning relations, implementation relations, central relations, and/or another such relationship. At step 86, one or more expressions are established. An expression may define a relation in one or more forms. Execution then proceeds to step 88, where relationships are built between nodes and then to decision block 90.

At decision block 90, a determination is made as to whether or not to associate one or more objects to one or more nodes. If it is determined at decision block 90 that one or more objects is hard to be associated with one or more nodes, execution proceeds to step 92, where the objects are associated and then to decision block 94. Alternatively, if it is determined at decision block 90 that one or more objects are not to be associated with one or more nodes, execution proceeds to decision block 94.

At decision block 94, determination is made as to whether or not to modify the order of associated nodes. The order may be selectively modified by a user. If it is determined at decision block 90 that the order is to be modified, execution proceeds to step 96 where the order is modified and then to step 98. Alternatively, if it is determined at decision block 94 that the order is not to be modified, execution proceeds directly to step 98. At step 98, a cognitive index database is populated and execution then proceeds to step 99, where the cognitive index is preserved for use.

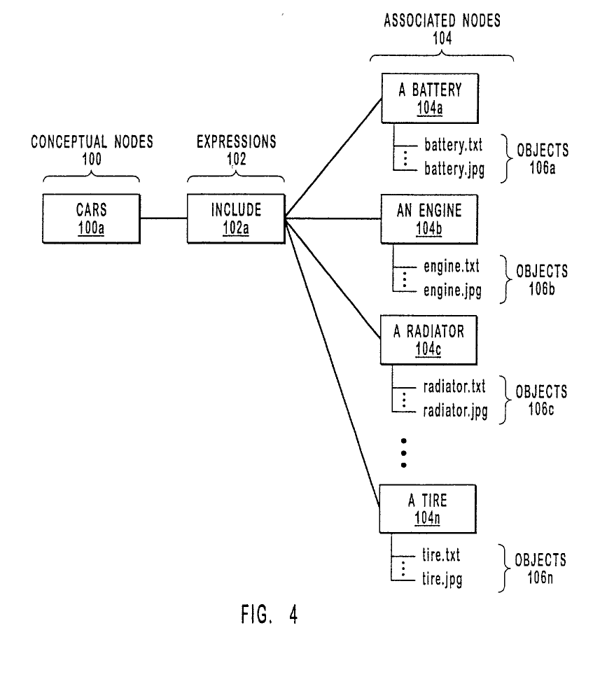

With reference to FIG. 4, an exemplary association is provided between a conceptual node 100 and one or more associated nodes 104. In FIG. 4, conceptual node 100a refers to the term “cars” and may be associated with one or more other nodes, illustrated in FIG. 4 as associated nodes 104, which include the terms “a battery,” “an engine,” “a radiator,” and “a tire.” The associated nodes 104a-104n are associated with conceptual node 100a through one of the expressions, namely expression 102a. Furthermore, each of the associated nodes 104 independently include one or more objects 106 related therewith to provide a variety of resources that may selectively be accessed by a user or program. The associations enable a variety of accurate statements or expressions that may be provided.

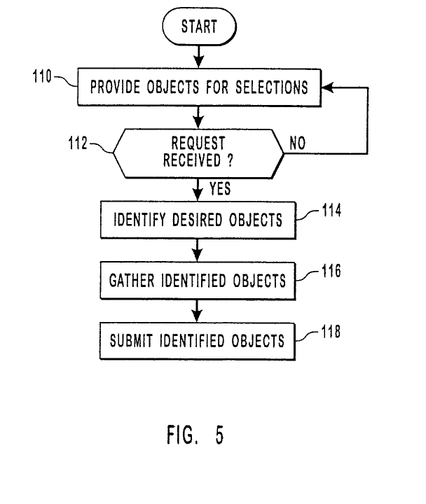

With reference to FIG. 5, an exemplary embodiment is provided for selectively providing objects from the cognitive index. In FIG. 5, execution begins at step 110, where one or more objects are provided for selection. The objects may be selected by user or alternatively by a set of instructions that are understood by or otherwise stored on a computer readable medium. Execution then proceeds to decision block 112 where determination is made as to whether or not a request is received for one or more of the objects provided in step 110. If it is determined at decision block 112 that no request has been received, execution returns back to step 110. Alternatively, if it is determined at decision block 112 that a request has been received, execution proceeds to step 114, where the one or more desired objects are identified, to step 16 where the one or more identified objects are gathered from the cognitive index, and to step 118 where the one or more objects identified in the request are submitted to the requestor.

### Computer Authoring, Learning, and Evaluation

The preferred embodiment of the method and system of the present invention is useful in providing evaluation of the ability of a user to comprehend presented data. In one embodiment, a method and system of the present invention is divided into an authoring portion and a presentation portion. The authoring portion allows a developer or author to take a pool of relevant data and organize it for presentation to a user. The presentation portion takes the data as organized by the authoring portion and presents it to the user. The presentation portion also generates questions that may be used for evaluation and feedback. Rules by which these questions should be generated are developed by the authoring system when the data is organized. It should be emphasized that unlike the prior art methods where pre-defined questions are simply presented to the user, embodiments of the present invention generate the questions to be asked utilizing the information in the index.

The data associated with the index includes objects that are in the form of text, sound, or graphics. The objects provide the basis for concept items, which are cross-related in contextual relationships, as provided above. By placing the objects in context with one another, learning becomes relevant and memorable to the student, and enables learners to integrate the new knowledge they have achieved with their old knowledge. By providing context, the author enhances the presentation portion of the present invention so that the student may master the subject matter more easily and more completely. Concepts are the fundamental building blocks of thought. Teaching and learning is a communication process that involves the analysis, reconstitution, expansion, and manipulation of concepts.

Concepts are placed in two categories for the purposes of the present invention. The first category is conceptual items and the second category is conceptual relations. A conceptual item may be a word, a group of words, a sound, an image, or anything that may symbolize a distinct idea. For example, an anatomy expert may want to work on the conceptual item, “tissue.” As part of the instructions, the instructor will speak of other conceptual items like “elasticity,” “protection against the external environment,” and “cells.” As the instructor speaks, the instructor conveys that elasticity is an attribute of tissue, that protection is one of its functions, that cells are its constituents. In such a way, the instructor specifies the conceptual relations among associated items. Such a conceptual relation always exists between two related items. Examples of common conceptual relations are whole-part, before-after, bigger-smaller, and so forth. Two items and adjoining relation compose a conceptual relationship.

There are two kinds of conceptual relationships. The first kind comprises general relations. Examples of general relations include whole-part, before-after, bigger-small. The second type of conceptual relationship is specific to intellectual disciplines from anatomy to zoology.

Specialized relationships employ distinctive items and relations. Intellectual disciplines may be better characterized by a few relations than by a multitude of items. If the instructor explicitly teaches the conceptual relations at the beginning of the course, the learners will understand faster and better what to do with the items as they encounter them throughout the course. The instructor may further assist the learners if the instructor helps them to see how the general relations and the specialized ones are inter-related. By creating such analogies, the instructor supplies context and better enables the students to integrate the expert knowledge with their own. Context makes the instructor's specialty relevant to them. Context also reduces the complexity of the student's learning. Thus, context enables the instructor to increase his or her value to the students.

Another benefit of creating conceptual relationships is that it provides a way to quantify knowledge. How much a person knows on a particular item is a function of how many relationships the item participates in. In other words, someone who is aware of five conceptual relationships in which an item participates is not as educated as someone who perceives 100 relationships. The same gauge may be applied to courses and course materials. Namely, the more conceptual relationships they contain, the more valuable they are.

The authoring system links conceptual items and relations in such a way as to allow the student to learn by the process of conceptual analysis. Although the instructor may place the knowledge within an alphabetical index, which may be manipulated in a computer system rather handedly, the best strategy for searching and learning is to use the conceptual relations rather than the alphabetical items. The human mind works to search for information based on conceptual relations. This is intuitive to the learners and researchers that lead to greater productivity in the learning environment.

The authoring portion and presentation portion of the present invention require an underlying relational (“ODBC”) database. The authoring portion is used to build the software course. The authoring portion includes drop down scripting features to shorten production time of the course development. The authoring portion is used to place objects like sounds, images, animations, movies, and text into the database. The authoring portion also creates hot spots, which are portions of the screen that illuminate so that the learner can understand exactly which part of an object is under discussion. The authoring portion is also used to create a discipline's conceptual relations and where the conceptual items are linked.

The authoring portion and presentation portion both utilize a question generation mechanism that utilizes the relationships defined in the authoring portion to generate questions automatically. Questions are formed when the question generation mechanism suggests possible conceptual relationships based on the actual ones entered earlier in the authoring portion. Those earlier relationships serve as templates for the questions. The question generation mechanism employs the conceptual relations as the stem of the question. It also replaces the predicate item with distractors or false answers.

The questions, however, do not accept just any item as a distractor. The distractors must be conceptually related to the answer. Otherwise, the distractors would be implausible to the question asked. The distractors may be related to the answer in several ways. For example, the relation counterfeit-counterfeit proposes distractors known to confuse novices. The terms “affect” and “effect” are counterfeits. Distractors may also be counterparts from other systems. Counterparts are concepts that serve the same function, but in different systems. For example, the red flanked duiker is a primitive species of antelope that lives in the forests of West Africa. The duiker occupies the same ecological niche as deer in North America, as rodents in South America, as muntjacs in Asia, as well as wallabies in Australia. The question generation mechanism would be able to select a mule deer, a muntjac, a capybara, and a wallaby as distractors for the answer (duiker), by way of a relation such as counterpart-counterpart during the authoring portion.

The presentation portion of the invention also serves as a tutor to the student. The presentation portion reads from the database, pulling out the lessons that the author and authoring portion created together. Afterwards, the student may take quizzes and exams from within the presentation portion.

Furthermore, the presentation portion allows the student to browse the conceptual relationships via an index known as a Nascent Index (TM). The nascent index is a tool that enables learners to explore not only content, but also context.

The nascent index functions as an alphabetic index, listing key terms and enabling the student to move directly to the instruction on the conceptual item. The nascent index also functions as a table of contents, enabling the student to understand the logical structure of the course. The nascent index functions as a glossary where the definition of each term may be easily viewed. With the table of contents and alphabetical index, the student may select any subject within the nascent index and then be quizzed subsequently.

Significantly, the nascent index leverages the conceptual relationships to enable the students to pursue a new kind of search. The student may select a term in a tree view of the nascent index to expand and reveal its conceptual relationships, or its context. The students expand and contract context as their questions emerge. This allows students to explore the course material conceptually, intuitively. This method eliminates the long-standing problem of alphabetical indexes where the student must know the pronunciation or spelling of a term before it may be retrieved. Further, this method of searching relegates the alphabetical indexes to a logical, consistent role, providing just the starting point of a conceptual search.

It is possible to develop a specialized hardware platform to be used for the instant invention. However, the authoring portion and the presentation portion may be used in conjunction with one or more computer devices. In one embodiment of the authoring system and the presentation system, extensive use of graphics (both video and illustrations), sound, and textural information are employed. In addition, the authoring portion and the presentation portion may include a graphical user interface operating environment such as Microsoft® Windows®, the Apple® (operating system, or another operating system.

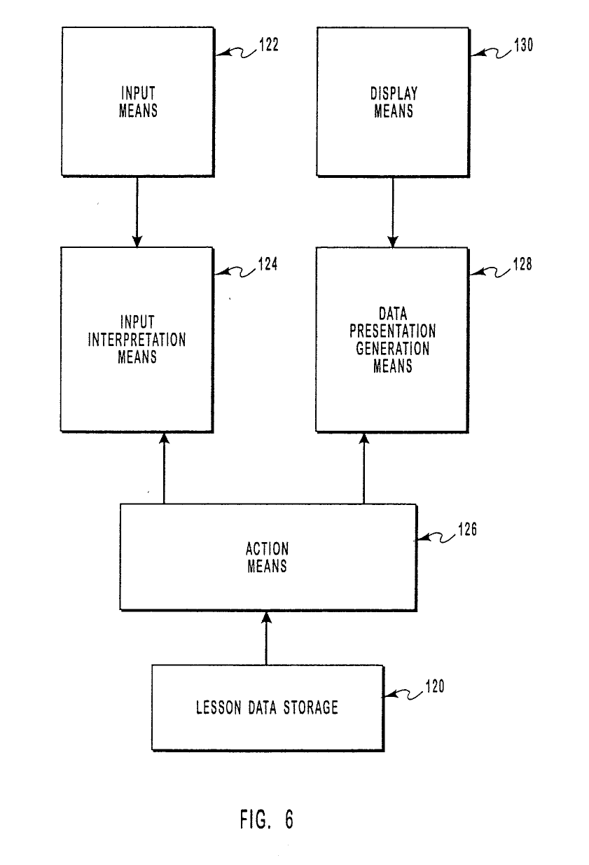

Referring now to FIG. 6, a structural diagram of the presentation portion is illustrated. As previously described, the presentation portion is designed to take lesson data as organized by the authoring portion and allow the user to interact with the data. The presentation portion is encoded in software, which is loaded onto the hardware platform to be executed by the processing unit or system. The software may reside on a computer readable media, as provided above.

In FIG. 6, the data as organized by the authoring portion is illustrated by the lesson data store 120. The lesson store 120 is typically located on a permanent storage media of the computer such as a removable or fixed disk or CD-ROM. As the data is utilized and presented to the user for interaction, the data is typically loaded from the disk into the computer memory. The data is stored in the ODBC database, an instance of which is Visual FoxPro®, provided by Microsoft Corporation of Redmond Wash.

Input is received from input means 122 and passed to input interpretation means 124. Input means 122 comprises the input means of the associated hardware platform. Input interpretation means 124 translates the input received and determines what actions should be taken. The appropriate information is then passed to action means 126, which performs the desired action.

Action means 126 extracts the appropriate information from lesson data store 120 to fulfill the desired task. After completing the desired task, which may involve processing the data extracted from lesson data store 120, the appropriate information is then passed to data presentation generation means 128. Data presentation generation means 128 formats the data in an appropriate manner and displays the data to the user via a display means 130.

Display means 130 comprises the means by which the authoring, learning, and evaluation system presents information to the user. Capability typically included in the embodiment is a visual display device and sound device capable of presenting text and graphics and sound, both illustrations and video.

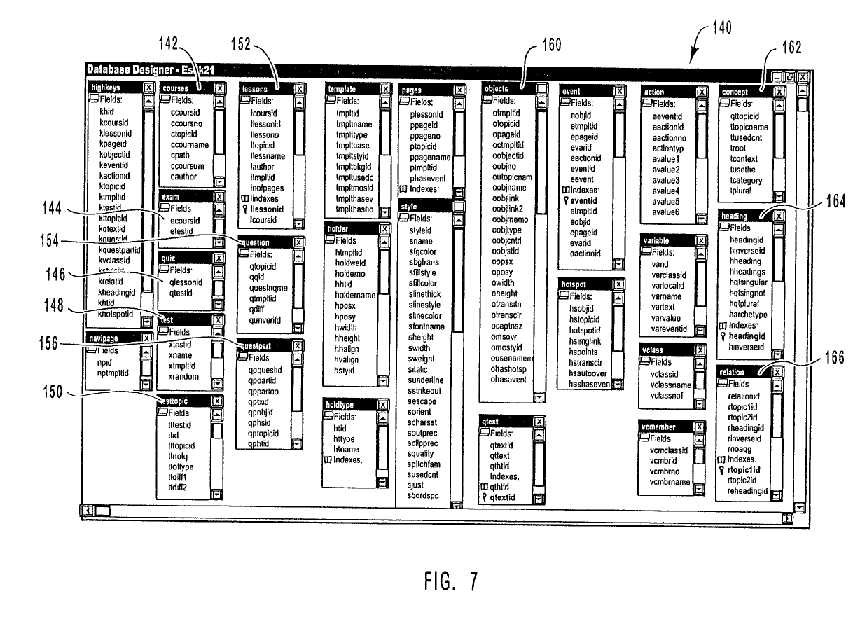

FIG. 7 illustrates an image view of a graphical user interface for the aspects of a database 140. Within database 140 are a plurality of components that are used to build the authoring portion and the presentation portion of the present invention. The components include a course component 142, an exam component 144, a quiz component 146, a test component 148, a test topic 150, and a lesson topic 152. Additional components include a question component 154 and a question part component 156. Four important components of database 140 include object component 160, concept component 162, heading component 164, and relation component 166. The remaining components are used to define keys, navigational pages, templates, holders, to define pages and style type, as well as to define text, events, and hot spots as are described and disclosed in U.S. Pat. No. 5,890,911.

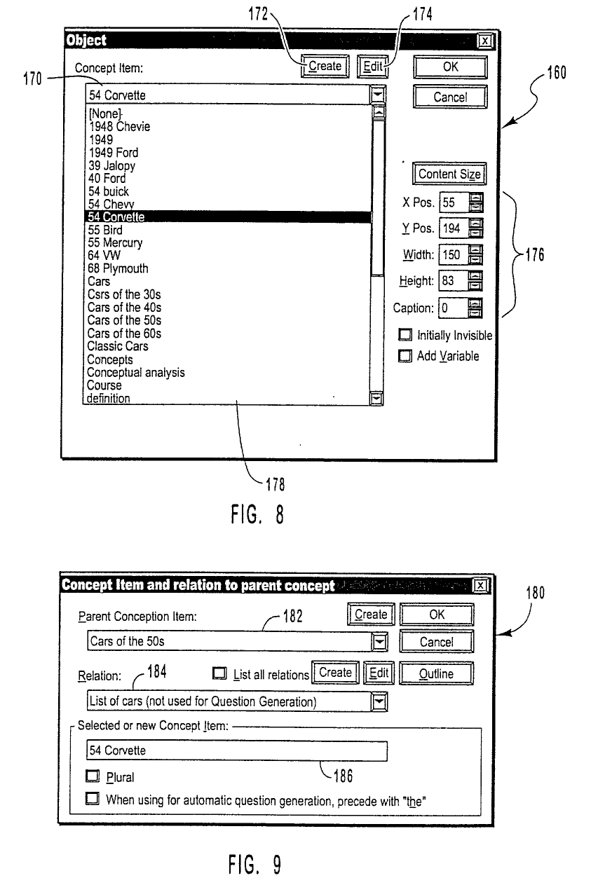

Object component 160 is represented in FIG. 8, which depicts a graphical user interface for the author where an object 170 is entered in the object field just below the concept item. Below the object are additional concept items that serve as objects. In this example, Classic Cars is the title and a plurality of classic cars from different eras defined within the concept item field. Additionally, relationships such as categories of eras are defined as objects. Once an object is selected, the author activates either the create icon 172 or the edit icon 174 in order to provide a proper relation of the object 170 with the other objects within the topic. The X position, Y position, width position, height, and caption found in serve in the editorial tool element 176 allow for the placement of a particular object 170 on a given page in accordance with principles of the present invention. Once the particular object 170 has been selected and placed (e.g., located on a desired page) within the content of the lesson material, the author may then add another object 170 or modify a pre-existing object 170 from the list of objects shown in list 178.

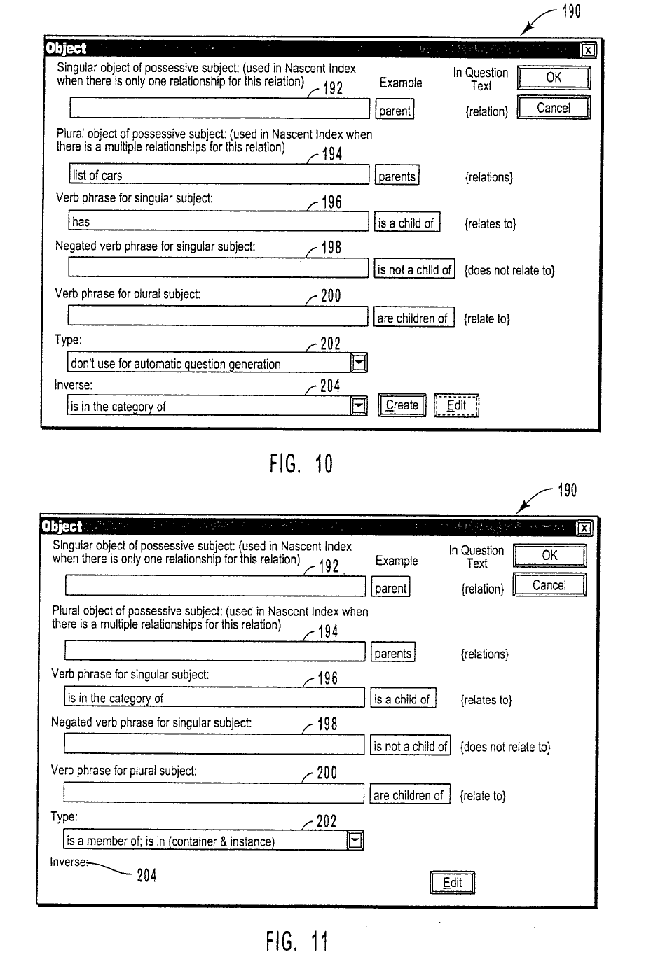

FIG. 9 depicts a concept item and relation to a parent concept field 180. The first field is parent concept item 182. In this example, the parent concept is Cars of the 50's. The next field is relation 184. In relation field 184, a list of cars has been defined and has been qualified not to be used for question generation. The selection of “not to be used for question generation” is an option available to the author for when a relation that exists isn't of interest to the author for testing or other learning purposes, but merely provides a link for indexing a distractor selection. A selected or new concept item field 186 is provided and it is equivalent to concept item field 170 of FIG. 8. Again, the concept item and relation may be modified or created by selection of either the create button or edit button. Upon creation of a relation for a parent concept with a new concept item, a new window is shown in FIG. 10.

FIG. 10 depicts the relation, phrase for nascent index, and automatic question generation field 190. Field 192 defines the singular object of possessive subject for use in the nascent index when there is only one relationship for this relation. Field 194 defines plural object of possessive subjects for use in the nascent index when there are multiple relationships for this relation. Continuing with the present car example, the plural object of possessive subject is list of cars. Next, field 196 defines the verb phrase for singular objects and in the given example it is “has.” Field 198 provides for a negated verb phrase for singular subjects, which means that a subject placed within this field would not be a child of or does not relate to the parent of either fields 192 or 194. Next, field 200 defines the verb phrase for the plural subject. Field 202 defines the type of subject. In the given example, the object has been selected “not be used for automatic question generation.” Lastly, field 204 defines the inverse of the object, which in this example is in the category that defines the relationship inverse.

FIG. 11 is the same as FIG. 10 in fields and numbering. In the example of FIG. 11, the verb phrase for a single subject has been selected to be “is in the category of.” Next, in field 202, the type is defined to be is a member of: is in (container & instance). No inverse field 204 is available in this option and therefore the inverse field is closed.

The author is free to select from a plurality of relationship types and a few examples are provided. One option is “don't use for automatic question generation,” which prevents the object from being used during the automatic question generation portion of the invention. Additional relationship builders include “is also known as,” “is similar to, but opposite feeling, connotation,” is like (analogous to, is like, parallel, corresponds), “is defined or explained as,” “is translation,” “is represented by (symbol),” “is remembered by (pneumonic),” and “is opposites with (inverse).” Additional builder strings include is confused with (counterfeit), is compatible with (requires, wants, needs), is incompatible with (dislikes, undesirables), performs, (function, purpose, what it does), is a result of (parent/child, produces/produced by), is a factor, reason, has an effect, plays a role, is a part of (whole & parts), is a member of, is in (container & instance), is a supporter (subscribes to). Additional connectors include is a kind of, is an example of (genus and species), is an attribute of (unity & attributes), has something in common with, is often accompanied by (companions, commonly associated with), is after/before, follows/proceeds (order related), is help for. The list of connectors is not deemed to be exhaustive and other relationships will be evident to those skilled in the art.

In order that the authoring, learning, and evaluation system may be more fully disclosed, FIG. 12 presents a basic flow diagram of one representative embodiment. When the system is started, the flow begins at step 210 labeled start. The system then selects the initial page from lesson data store 120, generates the show page array for that page and displays the page with its associated data to the user. Within the context herein, the term “page” shall refer to a unit of organized information. Pages may or may not be presented to the user. A page comprises various informational resources. These resources may include text, graphics, and/or sound. Within the scope herein, “graphics” refers to both illustration graphics, such as a picture, and video graphics. Pages may also have identifiers associated with them. Examples of identifiers are discussed in conjunction with the authoring portion below.

Because a page may contain many different resources, a method must be developed for ensuring that the resources are presented to the user in the appropriate format and with the appropriate control structures that allow the user to access the resources. In one embodiment, one such method comprises a show page array. The show page array may serve as a repository for the information needed to appropriately display the page, with its associated resources, to the user. For example, the show page array may contain such information such as where the graphic on the page is to be located, where the text on the page should be located, whether any sound associated with a page should be played immediately when the page is displayed, or whether a control button should be displayed that will allow the user to hear the sound when the control button is activated. Other information, such as branching information, control button layout, and the like, may also be included in the show page array. It is to be understood that there are other ways in which the resource information may be compiled and the concept of the show page array is given by way of example and not limitation.

Once the information of the page is displayed to the user, step 212 is entered where the system waits for the information from the user. Depending on the information displayed, and the resources available on the page, several actions may be possible. By way of example, FIG. 12 shows five possible actions the user can initiate.

If the data in the lesson has been organized in a manner that allows branching from the current part of the lesson to another part of the lesson, the user may elect to take the branch as indicated by branch step 214. If such action is initiated, the system will select the appropriate page from lesson data store 120, generate the associated show page array and display the page to the user. By way of example, and not limitation, if a branch is taken, control buttons may be added to the display that allows the user to return from the branch to a predefined location in the lesson. Such a predefined location may be a page where the branch initiated or to a different page in the lesson. Furthermore, it is anticipated that when a user has taken multiple branches, multiple control buttons may be displayed to the user in order for the user to return to various levels of the lesson.

In one embodiment, the branching capability provides a robust manner in which to hyper sequentially traverse information related to the current page. As used herein, the term “hyper sequentially” describes a manner of organizing pages so that they may be presented in a non-sequential manner. In addition to branching from the current page to another point in the current lesson, embodiments within the scope of the present invention allow branching to relevant information in an entirely different lesson or topic. Furthermore, other embodiments within the scope of the present invention allow branching to a location where questions covering the relevant information on the page are generated and presented to the user. In still other embodiments, it is contemplated that the branching capability may be utilized to branch to an entirely different lesson and questions on the relevant part of the entirely different lesson would be generated and presented to the user. In still other embodiments of the present invention it is anticipated that a branch may take the user to a point in the present or another lesson after which the system may sequentially present pages of data relevant to a particular topic without any further input from the user. Thus, a branch may take a user to a particular portion of the lesson where a “slide show” type presentation may be made.

In addition to the robust branching capability, embodiments within the scope of the present invention contemplate a robust return capability. Thus, not only may a user be presented with control buttons that return the user to a predefined location, but also when the end of a branch is reached, the user may be automatically returned to a predefined location. Such a predefined location may be any where within the current lesson or, perhaps, in a different lesson.

Another option is for the user to display the next page or previous page of the lesson. This step is indicated by next/previous page step 216 in FIG. 12. If this option is selected, the appropriate page will be extracted from lesson data store 120 and presented to the user as previously described. If there are no more pages to be displayed, another action may be initiated. For example, the current page may be displayed. As another example, the display portion may enter a mode where the user is asked questions. As a still further example, when the option is not available, the control button may be disabled.

In order to provide extended capability beyond the basic resources to a page, special regions called “hot spots” may be defined on the page. When these regions are selected or activated by a user, an action may occur. For example, the branching capability previously discussed may be implemented via a hot spot. When the user activates this hot spot, the previously defined branch may be taken.

Another potential use of a hot spot is as a field. A field hot spot may be used to display additional information when activated. For example, when the field is activated, a sound may be presented to the user. As another example, a video may be displayed, or a text box or other information may be displayed. Thus, fields may be used to enhance the presentation of information to a user. Returning to FIG. 12, field step 218 shows that the action that has been bound to the field is performed and the information on the page continues to be displayed.

Other uses for such hot spot regions may also be developed. For example, the concept of control buttons that direct the system to perform certain actions may also be implemented via this technology. The examples given herein are thus not to be construed as limitations.

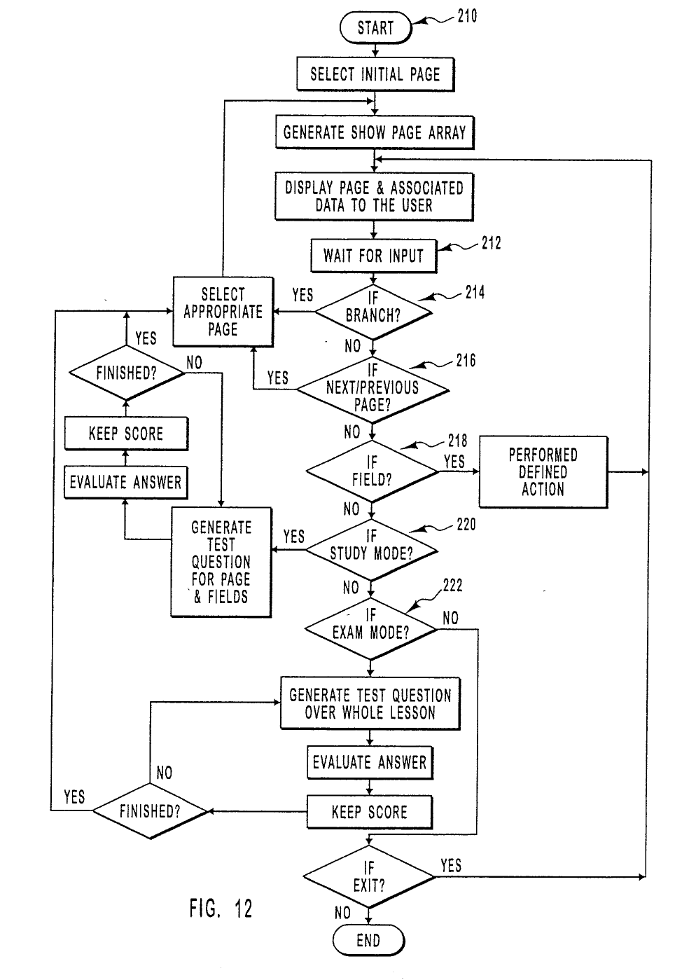

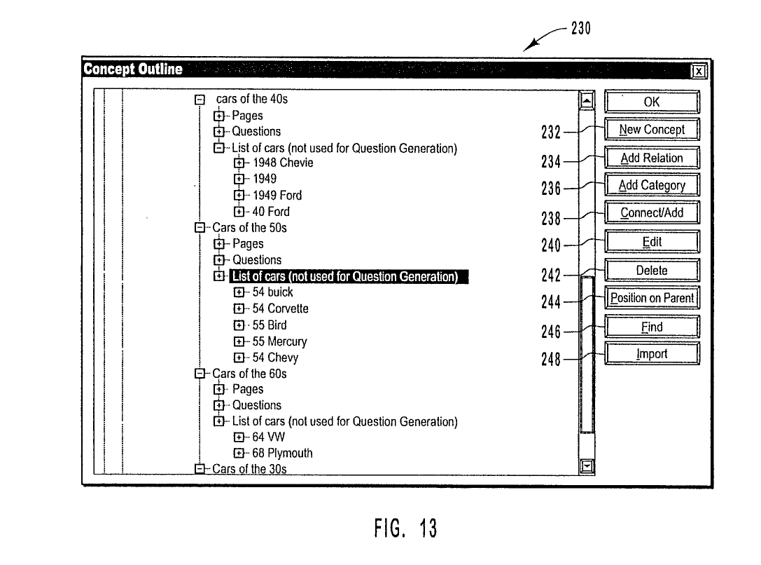

Once the author has provided enough topics and relations to the objects, a concept outline 230, as illustrated in FIG. 13 is generated from the information input by the author. FIG. 13 is a GUI depiction of a concept outline 230 in accordance with principles of the present invention. In the example of the classic cars above, an outline of the cars defined by particular times is disclosed. For purposes of illustration, the cars are defined in decades such as cars of the 30's, cars of the 40's, cars of the 50's, and cars of the 60's. Within each decade is included a page location as well as questions associated with that era. A list of the cars entered is also provided. At any time, the author may add a new concept via new concept icon 232, may add a relation via at relation icon 234, add a category via an icon 236, connect or add an object or concept to one another via connect/add icon 238, edit any object via edit icon 240, delete a field via delete icon 242, or position an object via Position on Parent icon 244. Additional functions include finding an icon via find icon 246 or importing a concept or object from another field via import icon 248. Concept outline 230 further serves as the nascent index previously described.

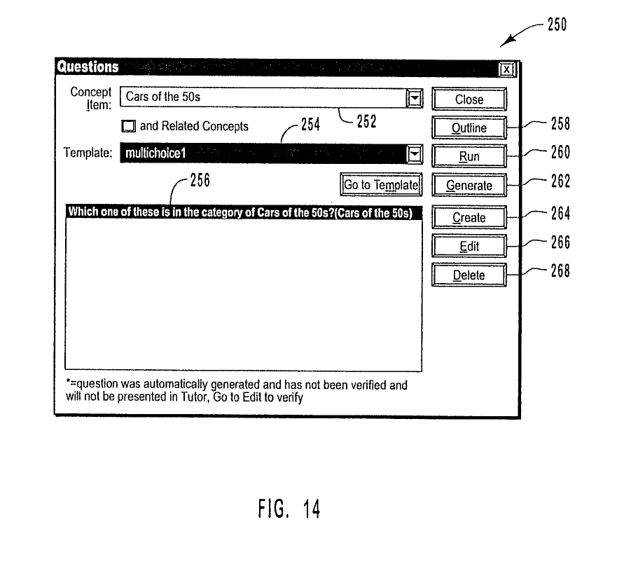

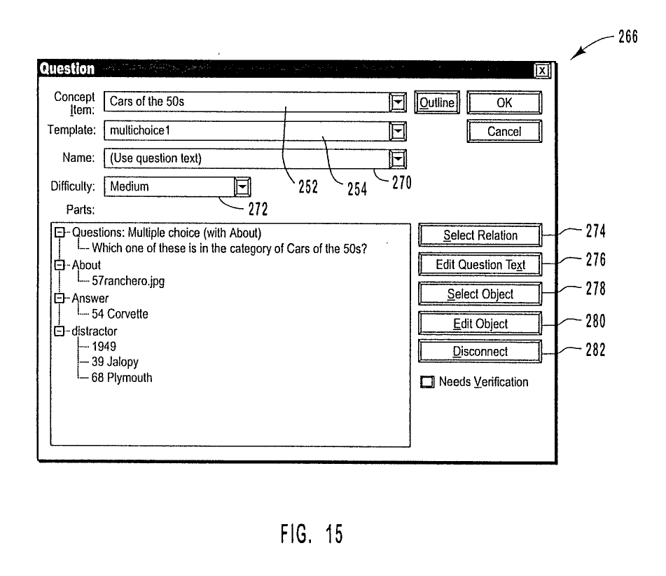

Next, a discussion of question generation is presented. FIG. 14 illustrates a GUI screen of the question selector 252 in accordance with the present invention. Question selector 252 includes a concept item field 254, which serves as the topic for the question to be generated. The author may select from a plurality of question types in question type field 254, which may include multiple choice, matching, true/false, fill in the missing words, or essay type questions. Question field 256 displays the actual question generated for review by the author. In this case, the question is: Which one of these is in the category of cars of the 50's? Question selector screen 252 further includes an outline icon 258 to view the types of questions for the concept item in outline form. A generate selector 262 is activated to perform a question generation operation. A run icon 260 allows the author to select various questions for review. Additional buttons include create 264, edit 266, and delete 268, which functions have previously been described. Each question that is automatically generated by the question generation mechanism of the present invention is noted as not being verified by the author and will not be presented in the learning portion of the invention. At this point, the author selects the edit button 266 to verify that the question conforms with the author's goals of evaluating the student's learning of subject matter studied. An example of verification is depicted in FIG. 15.

FIG. 15 is a GUI screen of question verification and edit option 266. The question verification includes concept item 252, template 254, name field 270, difficulty field 272, and a parts field. Name field 270 defines the name of the question asked. Difficulty field 272 selects the level of difficulty defined by the author for the question selected. In this example, the question is of a medium difficulty. Easy, medium, hard, and challenging are types of difficulty levels. Other types of difficulty levels will be evident to those skilled in the art and are not intended to limit the scope of the present invention. The parts field lists the question type, what the actual question is, what the question is about, the answer to the question, and selected distractors associated with the question. In the example depicted in FIG. 15, the question is: Which one of these is in the category of cars of the 50's? The answer is the '54 corvette and the distractor cars include: an automobile selected from the year 1949, a 1939 jalopy, and a 1968 Plymouth.

The present invention improves upon the prior art methods in that the distractors selected in FIG. 15 are in the same context as the answer of FIG. 15. Namely, each distractor happens to be a car, albeit in a different era than the era of the question asked. In selecting the question, the question may present either an image of each of the cars to test the learner or student's knowledge of being able to identify a car on sight. Other options include providing video images of the car or audio sounds of the car for identification by the student.

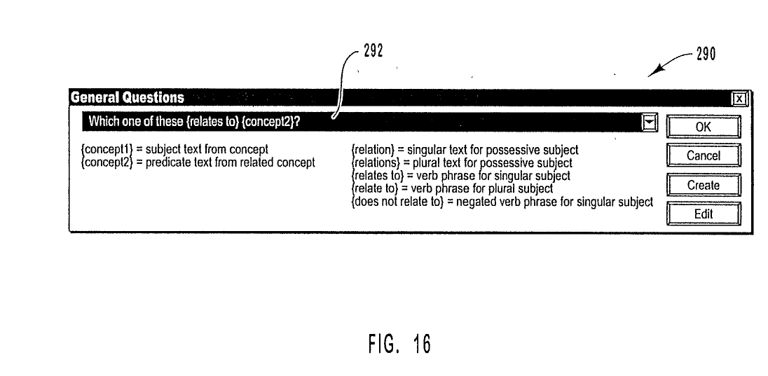

The question field 266 allows the author to modify the question. This may be achieved through changing the relation via select relation button 274, editing the question text via edit question text button 276, selecting an object via select object button 278, editing an object via edit object button 280, or just disconnect via disconnecting button 282. Should the author select edit question text button 276, the authoring portion directs the author to a GUI screen allowing the author to evaluate questions in a general scope as shown in FIG. 16.

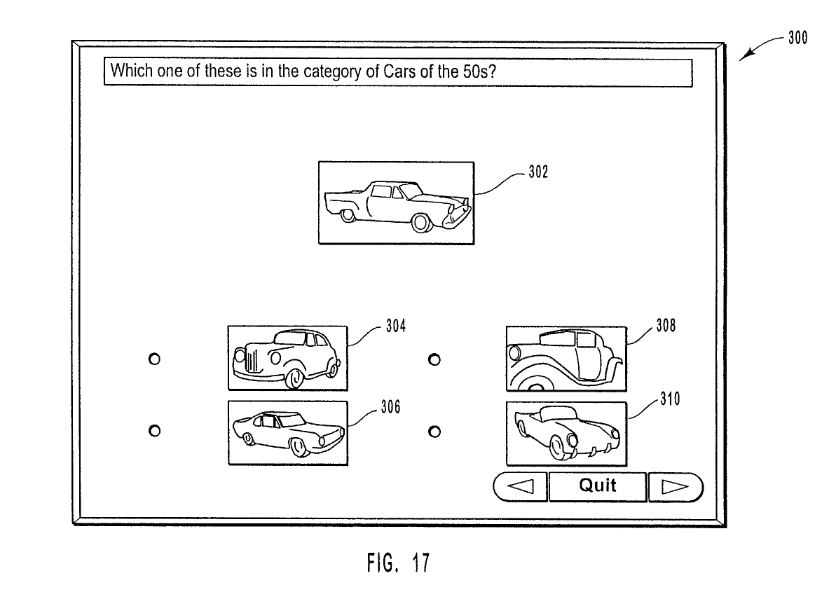

FIG. 16 depicts the general questions 290. The general question field is shown in field 292. The example in this illustration is: Which one of these (relates to) (concept2)? For example, (concept2) may be the predicate text from the related concept and (concept 1) may be the subject text from the concept. Once the author is satisfied with the general question type, the author may modify the specifics of a question. A sample question illustrative of the question generator mechanism within the authoring portion of the present invention is depicted in FIG. 17.

FIG. 17 illustrates a graphical view of question 300 as generated by the implementation demonstrated above. The question is: Which one of these is in the category of cars of the 50's? A representative car is illustrated in the image 302. Possible answers are depicted in images 304-310. In this example, images 304-308 are distracter answers while image 310 is the right answer.

As demonstrated in the background section, current learning, response, and evaluation systems have limitations on their ability to provide effective feedback to a user. In order to overcome these limitations, one preferred embodiment contemplated within this invention has the ability to enter a study mode for a student-selected topic. In FIG. 12, this capability is represented in study mode step 220. This mode may be available at virtually any point in a lesson. When a user selects study mode, the presentation portion generates topical test questions for the page and fields currently displayed. The user selects an appropriate answer that is evaluated. The system keeps track of the score achieved by the user.

In study mode, it is possible to develop a wide variety of exit rules. Exit rules are designed to exit the study mode when a specific event occurs. For example, a control button may be provided that allows the user to exit the study mode at will. As another example, the system may be directed to ask a predetermined number of questions and exit when the questions have been asked. As still another example, the system may ask a predetermined number of questions after which the user's score is evaluated. If the score is above a certain threshold, then the study mode will be exited. If, however, the score is below the threshold, then an additional set of questions may be asked.

In one embodiment, the author determines the exit rules when the lesson is constructed. In another embodiment, the user sets the exit rules. In another preferred embodiment, the author and the user determine different aspects of the exit rules. As demonstrated by these examples, a wide variety of exit rules are possible and the examples given should not be interpreted as limiting the scope of this invention.

Upon exiting from the study mode, a wide variety of options are available. In one embodiment, upon exiting, the presentation portion returns to the page that was displayed before study mode was entered. In another embodiment, the presentation portion displays the next page of the lesson. In still another embodiment, the user is presented with a list of options from which to choose what action the presentation portion should take.

Since scores are evaluated when the study mode is entered, if a user utilizes the study mode for most or all of the information presented, an overall score covering the material in the lesson may be presented to the user without the need to resort to an overall examination on all material contained in the lesson. Furthermore, if desired, the user may receive a current score at any point in the lesson. This ability to provide scoring information at any point in the lesson greatly increases the effectiveness of feedback to the user. The user is able to evaluate how well the material is being learned while the learning process is still occurring. Thus, users are more likely to continue to study information that is not well learned rather than moving on to other topics. This ability, then, represents a significant improvement over tests where feedback is provided to the user after the focus of learning has shifted to new material.

A wide variety of scoring rules may be developed for use with the instant invention. In one embodiment, simple rules are contemplated. Such rules may include keeping track of the number of questions answered correct and the number of questions answered incorrect. If questions of a multiple choice format are asked, the question may be allowed to stay on the screen until the correct answer is selected. In this instance, a variable number of points may be awarded based on how many tries it takes to select the right answers. For example, if the correct answer was selected on the first try, 4 points may be awarded. If selected on the second try, 2 points may be awarded. Finally, 1 point may be awarded if the answer is selected on the third try. No points may be awarded for any subsequent selections.

More complicated scoring rules may also be developed. Such scoring rules include rules that deduct the number wrong from the number right. Further, testing theories may be used to develop still more complicated rules. Such rules may be useful, for example, if the system was being used to determine the likelihood of mastery of a given subject. Further, such rules would be necessary if scores from one person on one test were to be scaled relative to scores from another person on another test in order to standardize a test. Those skilled in the testing art may be able to develop such scoring rules.

Finally, a wide variety of options may be developed to display scoring information. In one embodiment, scores are displayed continually. In another embodiment, scores are displayed when requested by a user. In still another embodiment, scores are unavailable to the user and are only available to an instructor or administrator. Further, scores may be cumulative, or may be broken down by topic or section.

In order to further enhance feedback, it may be desirable to present a test covering all information in the lesson. In one preferred embodiment, this is achieved by entering an exam mode. In FIG. 12, this mode is illustrated by exam mode step 222. When exam mode is entered, questions over all material in the lesson are generated and presented to the user. Answers to the questions are evaluated and a score is kept. The score may be presented to the user as questions are asked and answered, or the score may be held until the exam mode is exited. In addition, the score may be held until the user requests the details. Finally, the score may be unavailable to the user and only available to a teacher or instructor.

As in the study mode discussion, the exam mode may be provided with exit rules. The author, the user, or a combination of both may determine the exit rules. Again a wide variety of exit rules are possible. By way of example and not limitation, one possibility is to exit the exam mode when requested by the user. Another possibility is to exit the exam mode when a determination has been made that the user has either mastered the material or has clearly not mastered the material. Such an exit rule may probably require application of various testing theories that are known to those skilled in the testing art. As another example, the exit rules may require a certain number of questions to be answered correctly before the mode is exited. As a final example, a specified number of questions may be asked, and depending on the score achieved, the mode may be exited or further questions may be asked.

Upon exiting, a determination must be made as to what should occur. For example, one possibility is to exit the lesson when the examination mode is exited. Another possibility is to allow the user to return those sections of the material where further practice is needed. For example, if a user determines that they do not know the answer to questions regarding a certain topic, the user may chose to exit in such a manner as to bring the information on that topic to the screen. Alternatively, it may be possible to exit the exam mode in such a way so as to start another lesson. Other exit rules may be available and the type of exit rule employed should not be interpreted as limiting the scope of the present invention.

It will be appreciated that the learning, response, and evaluation system may have numerous other capabilities. For example, lessons may be organized in order to present a table of contents to enable the user to go directly to that part of the lesson that is of most interest. In addition, a search capability may be included. Such a capability may be structured in order to allow the user to find a particular word or topic. Alternatively, such a search capability may allow the user to locate and go to a particular page in the lesson. Furthermore, a scan capability may be included. Such a capability allows the system to begin at a particular point in the lesson and present a page for a length of time before automatically presenting the successive page. In this manner, a user may quickly review a particular set of pages in a lesson without manually moving through the pages.

In addition to these capabilities, a third testing capability may be included. For example, the presentation portion of the system may be structured to keep track of the information seen by the user. A test may then be generated that covers only the material that the user has studied. In addition, the system may keep track of the scores during the study mode and the exam mode or in a mode that tests on the materials seen by the user, the system may then emphasize questions where the user has displayed a particular weakness. In this manner, the user may be queried more on the material he/she has to master rather than on the material that he/she has already mastered.

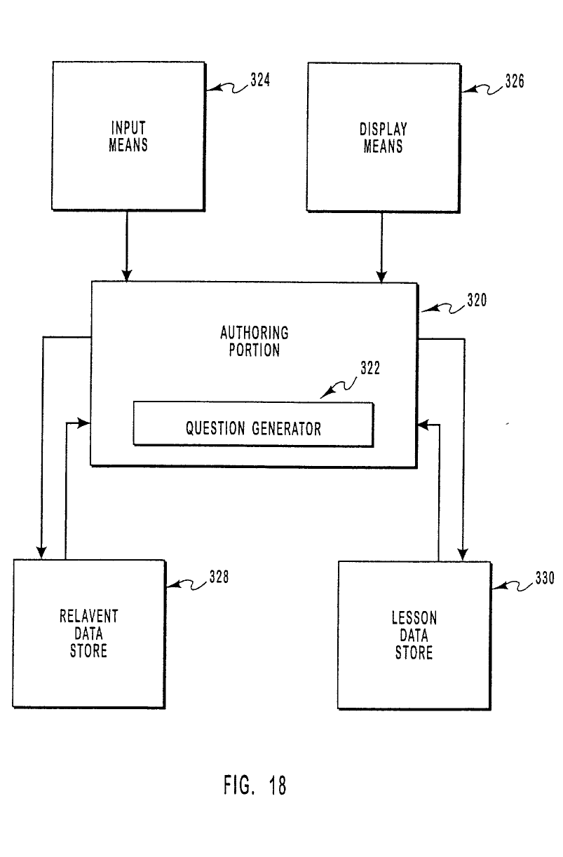

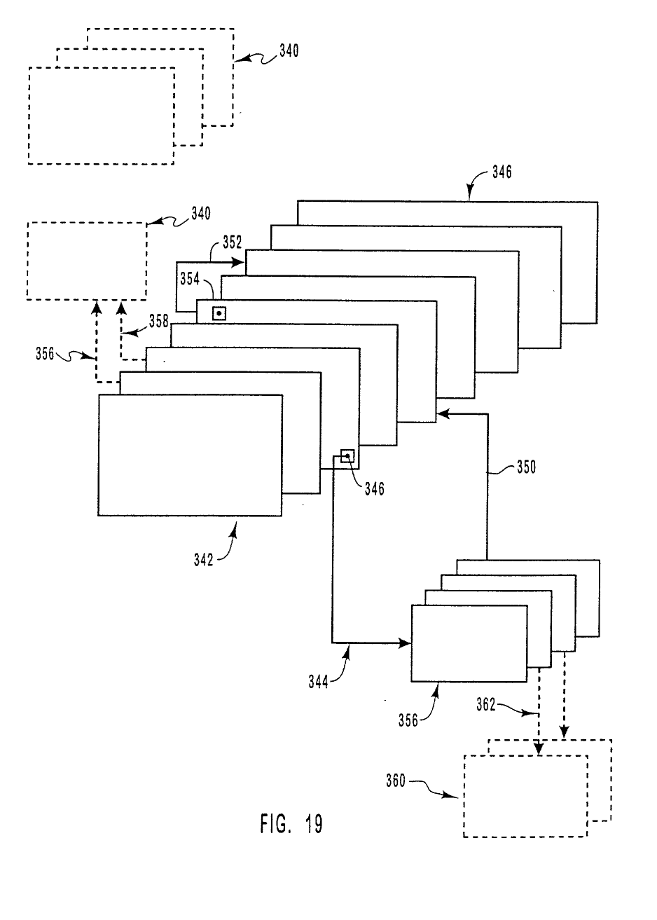

FIG. 18 presents a top-level structural diagram of the authoring portion of the learning, response, and evaluation system. As previously discussed in conjunction with the presentation portion, authoring portion 320 may be encoded in software that is loaded onto the hardware platform for execution by the CPU. The software may reside on a computer readable media.

Authoring portion 320 receives input from input means 324 and displays information on display means 326. Input means 324 and display means 326 are part of the hardware platform as previously described with regards to the presentation portion. Thus, input means 324 comprises such elements as a keyboard, mouse, pen, voice input system, and the like. Display means 326 comprises such elements as a screen to display text and graphic material. Display means 326 also comprises means to play a sound for the user. Sounds include any sound that may be relevant to the lesson such as voice or music.

As illustrated structurally in FIG. 18, the primary focus of the authoring portion is to take data from relevant data store 328 and organize it into the proper format for inclusion in lesson data store 330. Lesson data store 330 is simply a name for the file containing the lesson data. Relevant data store 328 and lesson data store 330 may reside on the hardware platform's permanent computer readable media, such as a removable or fixed disk or CDROM. The specific concepts embodied in this invention are designed to provide an intuitive set of tools that allows an author to quickly and easily take a pool of data from the relevant data store and organize it into a lesson. The inventive concepts embodied herein allow the lesson data store to be produced without conventional programming. In combination, the concepts presented and embodied in this invention provide two fundamental benefits over the prior art. First, the time needed to develop a lesson by organizing relevant data into lesson data is dramatically reduced. Second, because the inventive concepts are combined in a unique manner, use of the authoring portion is highly intuitive. Thus, the time it takes to learn how to operate the authoring portion is dramatically reduced.

Referring first to FIG. 19, a conceptual representation of a lesson is presented. As previously discussed, in one preferred embodiment a lesson is organized into pages. A page is a unit of information and may contain a plurality of resources. Possible resources include text, graphics, and sound. In one embodiment, a plurality of page types may be defined. Page types may include both visible pages and hidden pages. Visible pages are those pages that will be shown to the user when the lesson is activated via the presentation portion. Hidden pages are those pages that contain information that is not directly presented to the user in a form that is to be learned. The use of hidden pages will be explained in greater detail in the discussion below that describes how questions are generated.

As depicted in FIG. 19, visible pages 346 are arranged so that they may be presented in a variety of ways. For example, FIG. 19 depicts a lesson that has a main pathway, shown generally as 342, where visible pages 346 are presented in a nominally sequential manner. All lessons, however, do not need to be organized in this manner. The authoring portion allows a developer or author to have ultimate control over any and all pathways that a user of the lesson may potentially take. For example, the lesson in FIG. 19 has a branch path, shown generally as 344, which may be reached by activating branch link 62 that has been tied to hot spot 346. In addition, the lesson in FIG. 19 also has a branch defined through the main pathway. This branch is taken by activating branch link 352 that is tied to hot spot 354. This branch illustrates that branches may be defined through any number of visible pages.

Returning again to branch path 344, which is reached through branch link 62, a feature of one preferred embodiment of the present invention is illustrated. As depicted, branch path 344 is reached only when the user activates hot spot 346. Thus, if the user went through the lesson without activating hot spot 346, the information in branch path 344 would never be presented to the user. In contradistinction, the pages reached via link 352 when hot spot 354 is activated would have been reached any way if the user had continued through the lesson main path.

Also illustrated in FIG. 19 is return link 350. Return link 350 is used to determine what happens when the end of branch path 344 is reached. In the embodiment shown in FIG. 9, return link 350 takes the user to a point in the lesson different from where the user initiated the branch. As previously discussed, such a return link may be utilized to return to a variety of locations. For example, return link 350 may be used to return the user to the initial page that initiated the branch. As another example, return link 350 may be used to move the user to a particular point in the lesson where questions are generated.

In addition to the single return link shown in FIG. 19, it is possible to generate a plurality of return links from branch path 344. For example, each page in branch path 344 may have a control button that allows the user to return to the main path in a predetermined location.

In order to enhance the learning process and to more fully determine what level of skill has been obtained, it may be desirable to test on principles that have not been directly presented to the user and that are only analogous to those that have been presented to the user. Although there are many potential ways to identify information that should be used in testing, but which should not be presented to the user, in one embodiment, a hidden page type is used. In FIG. 19, phantom lines represent hidden pages 340.

Depending on the particular type of lesson and the information involved, certain analogous information may be relevant to the entire lesson. Other analogous information, however, may only be relevant to a single page or a group of pages. In order to identify the portion of the lesson that is relevant to the analogous data contained on hidden pages, one embodiment utilizes hidden page links. When information contained on a hidden page is relevant only to a particular page or a particular group of pages that information may be linked to those specific pages with hidden page links.

In FIG. 19, hidden page 70 is relevant to only two visible pages. Hidden page 70 is thus linked to those relevant visible pages by hidden page link 356 and hidden page link 358. Hidden data page 360, however, is only relevant to a single visible page. Thus, hidden page 360 is linked to the single relevant hidden page by hidden page link 362. In contradistinction, the group of hidden pages identified generally by 340 is relevant to the entire lesson. Thus, these pages are not linked to any specific page. It will be appreciated that other methodologies may be developed that identify the applicability of a page of hidden data. For example, hidden pages may have associated with them a scope parameter that identifies the range of pages in the lesson that are relevant to that page. In addition, default rules of association may be developed. The manner in which hidden pages are associated with visible pages has been given by way of illustration and should not be considered limiting of the scope of this invention.

Because of the wide variety of information that may be presented via the individual resources owned by a page and given the virtually infinite way in which pages may be organized into a lesson, it is imperative that the authoring portion include a robust set of tools that allow an author to quickly and easily assemble information into a completed lesson. A method and system for generating lesson material is described in commonly assigned U.S. Pat. No. 5,890,911.

Since the purpose of the authoring portion is to allow an author to rapidly create a lesson by organizing relevant data into the proper format, means for quickly and easily handling various resources that are to be placed on a page is necessary. There are many ways of providing such a means. One way of providing such a means is to have a command line where the author enters commands that cause the authoring portion to place resources at various points on the page. In the alternative, selections or list boxes may be used. In the presently preferred embodiment, however, a series of control buttons is used to provide “tools” that are utilized by an author to quickly and easily manipulate resources that are to be placed on a page. Potential resources that may be placed on a page include graphics, text, and sound. Individual tools tailored to manipulating each of these resources are thus desired in the preferred embodiment.

One primary advantage of the instant invention over the prior art is the ability to generate a lesson with testing and question capability without ever generating any questions. In other words, the instant invention takes the data available in the lesson and creates or generates questions from the data. Thus, an author need not generate questions when the lesson is created. In order to provide such capability, means for generating questions are included in one embodiment. The means for generating questions is illustrated in FIG. 18 by question generator 322.

In one embodiment, questions are generated at two fundamental times. The first event that will cause questions to be generated is when display question tool as shown in FIG. 14 is selected in the author portion. Another event that will cause questions to be generated is when the user selects a particular mode in the presentation portion. In one embodiment of the presentation portion, such modes include the study mode and the exam mode. In one embodiment, questions are generated by the authoring portion and by the presentation portion in exactly the same manner. In another embodiment, the authoring portion and the presentation portion generate the questions in exactly the same manner except that the presentation portion generates the questions in a random fashion whereas the authoring portion generates the questions in a non-random fashion.

When the system generates questions, each question has three parts. The first part is the question part. The question part is the actual question that is asked. The next part is the right answer part that represents the right answer to the question. Finally, there is the wrong answer part. The wrong answer part comprises one or more wrong or distractor answers to the question.

In general, the question generation process pulls the question part, the right answer part, and the wrong answer part from the various resources contained on Concept Outline 230 for the selected lesson. When questions are generated, question template 254 or format of FIG. 14 is utilized. The particular type of format used is dependent upon the resources selected for the question part, the right answer part, and the wrong answer part of the question.

In one embodiment, the questions generated are multiple choice type questions. In this embodiment, one resource is selected as the question, and another resource is selected for the right answer part and the wrong answer part. The resources are then arranged on a page and presented to a user according to the type of resource utilized. Thus, if the question part comprised a graphic and the right answer part and wrong answer part comprised a sound resource, then the graphic and a plurality of sound resources would be arranged on the page and presented to the user. The user may then select from among the choices presented.

In one embodiment, a single type of resource is selected for the question part, and a single type of resource is selected for the right answer part and the wrong answer part. In another embodiment, a plurality of resources is selected for the question part and a single type of resource is selected for the right answer part and the wrong answer part. In still another embodiment, a single type of resource is selected for the question part and a plurality of resources are selected for the right answer part and the wrong answer part. In still another embodiment, a plurality of resources is selected for both the question part and for the right answer part and wrong answer part.

In one embodiment, the questions generated also include fill in the blank type questions. In one embodiment where fill in the blank type questions are utilized, the question part of the question comprises a single type of resource and the right answer part and wrong answer part comprise fill in the blank regions. In another embodiment utilizing fill in the blank questions, the question part comprises a plurality of resources and the right answer part and wrong answer part comprise fill in the blank regions.

When questions are presented to a user, the question part and right answer part and wrong answer part may be laid out on the page in any logical manner that accommodates the resources that comprise the various parts of the question. Where a sound resource is presented, the question format may be configured to automatically create a visual representation of the sound that may be activated by the user to hear the sound. When a plurality of resources are used for a single part, the resources may be laid out so as to clearly delineate the question part from the right answer part and wrong answer part. When multiple-choice questions are presented, the system may be configured so as to automatically generate control buttons or check boxes that may be activated by a user to select a given answer. When fill in the blank type questions are presented, the system may automatically generate regions for the question to be answered.

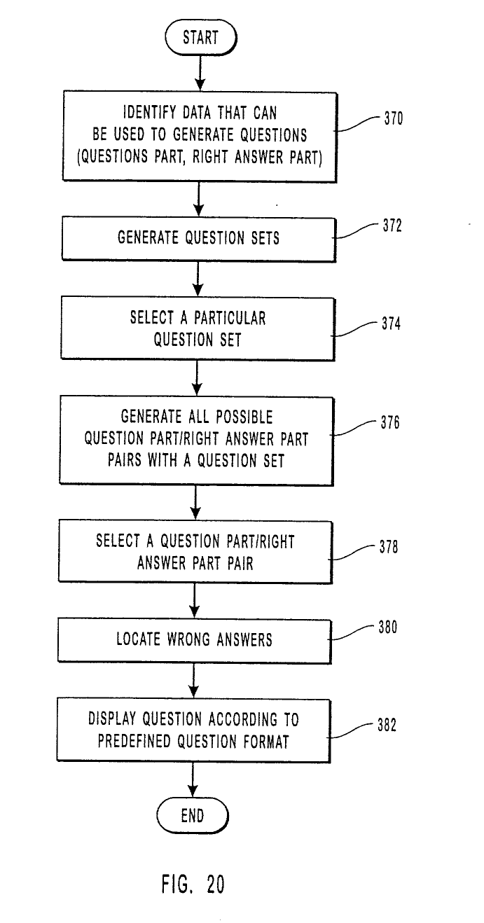

Referring now to the FIG. 20, a basic flow diagram of the question generation process is presented. The question generation process begins in step 370 with the system identifying all data that may be used to generate the question. As indicated in FIG. 20, this includes identifying sources of data for the question part and the right answer part of the question. In performing this search for relevant data, the concept relations previously described are utilized. In one embodiment, when the question generation routine is invoked via the authoring portion with a data page is displayed, the scope of the search is such that all possible questions based on the relationships established in the authoring portion of the lesson are generated. In another embodiment, when the question generation process is invoked in the authoring portion and the author is testing the questions that may be asked about the entire lesson, the scope of the search is such that all questions pertaining to the entire lesson may be generated. In a still further embodiment, when the question generation process is invoked by the user in the presentation portion via exam mode step 222, as illustrated in FIG. 12, the scope of the search is directed to data necessary to generate questions over the entire lesson, according to the relationships defined by the author.

Other embodiments may be developed that tailor the search scope in order to test on various aspects of the lesson. For example, the search scope may be tailored to finding information necessary to generate questions over a particular topic included in a lesson. As another example, the search may be tailored to finding information necessary to generate questions over all material that has been presented to the user but exclude material that has not been presented to the user.

Returning to FIG. 20, after the data has been identified, which may be used to generate questions over the appropriate scope, the next step 372 is to generate question sets. Question sets are used to identify where the question part and right answer part are to be found.

Once the question sets have been identified, a particular question set is selected in step 374. In one embodiment, the method used to select a particular question set depends on where the question generation process was invoked. For example, if the question generation process was invoked from the authoring portion, it may be desirable to select question sets in a sequential, non-repetitious fashion. This allows an author to see all potential questions that may be generated within the given scope. If, however, the question generation process is invoked from the user portion, it may be desirable to randomly select from among the available question sets. This allows questions to be generated in a random fashion, which provides better feedback during the learning process.

Returning to FIG. 20, once a particular question set is selected, all possible question part/right answer part pairs associated with that question set are generated in step 376. In order to generate all possible question part/right answer part pairs, means to identify potential question parts and right answer parts are included.

As an example, consider an embodiment where a topic contains a graphic resource, a sound resource, and four separate text resources. From these resources, it is possible to generate questions from each of the individual resources and from combinations of the resources. In one embodiment, the possible question parts for these resources are graphic, sound, text 1, text 2, text 3, text 4, graphic-sound, graphic-text 1, graphic-text 2, graphic-text 3, graphic-text 4, sound-text 1, sound-text 2, sound-text 3, and sound-text 4. The same combination of resources may also be utilized for possible answer parts. In addition, it is possible to identify a fill-in-the-blank answer part. In one embodiment, four separate fill-in-the-blank answer parts are identified.

Once all possible questions part/right answer part pairs are generated, one question part/right answer part pair is selected in step 378 for the individual question. As previously indicated, how the question part/right answer part pair is selected may be dependent upon where the question generation process is invoked. For example, if an author invokes the question generation process from the authoring portion, the question part/right answer part pairs may be selected in a sequential, non-random fashion so the author may view all potential questions that may be generated from a selected question set. Alternatively, if the user in the presentation part invokes the question generation process, the question part/right answer part pairs may be selected in a random fashion so as to enhance the effectiveness of either a study mode or an exam mode.

As previously indicated, not only may the particular question set be selected at random from among the question sets available, but also the particular question part/right answer part pair may be selected at random. This random methodology is particularly useful in the presentation part. In one embodiment, it is desired to randomly generate questions when the question generation process is invoked from the presentation portion in such a manner that questions are presented without repetition. Many procedures are available in order to accomplish selection of both question sets and question part/right answer part pairs in such a manner that the questions presented to the user are generated without repetition.

Once a question part/right answer part pair has been selected, the next step 380 is to locate wrong answers that are appropriate for inclusion in the question. The wrong answers are selected based on the context relationship of the tested topic in accordance with the teachings of the present invention.

Once the right question part/right answer part has been identified along with a sufficient number of wrong answers for the question format that is to be presented, the question is displayed in step 382 according to the pre-defined question format.

If the routine is invoked from the authoring portion, mechanisms allows the author to quickly and easily scroll through all possible question part/right answer part pairs drawn from all possible question sets. In one embodiment, means by which the question part and right answer part pairs may be viewed is provided. In the present embodiment, the means comprise menus, dialogue boxes, list boxes, icons, control buttons, and the like, which are normally associated with the GUI environments illustrated for this system.

In one embodiment, the authoring portion allows the developer or author to have control over the number and/or type of questions asked in the user portion. A simple analogy is that the authoring portion specifies the rules that may be used to generate questions in the presentation portion. Thus, means by which an author may control the scope of questions asked is provided. In one embodiment, the means allows the author to preview all possible questions that may be asked and mark those questions that should be excluded from the questions which may be asked in the presentation portion. In another embodiment, the means comprises the ability to eliminate questions involving a particular resource. In still another embodiment, the means comprises the ability to eliminate fields that may be used to generate questions in the presentation portion. It is anticipated that a wide variety of tools that allow the author to tailor the questions to be generated in the presentation portion are provided.

In order to enhance the evaluation and feedback from the invention, other features may be included. For example, any of the testing methodologies employed by those in the testing art to evaluate a user's comprehension and grasp of the material may be included. Thus, the instant invention may be designed so as to vary the number and difficulty of questions in order to ascertain mastery of a particular subject. In one embodiment, questions have associated with them specific parameters that allow evaluation of the question. In one embodiment, these parameters include a measure of difficulty, a measure of the time a user takes to answer the question, and a measure of a passing or failing score.

Questions generated by the instant invention may also have an associated feedback parameter. Such a feedback parameter may include actions taken upon completion of the question. For example, feedback may come in the form of correct or incorrect response indications. As another example, feedback may be descriptive, which includes situations where additional information is presented to the user. Thus, once a question is answered, the user may be informed of his or her score in relation to a predefined threshold, or in relation to other scores. Other additional information may also be presented with descriptive feedback.

Feedback may also be prescriptive, which helps the user reinforce his or her knowledge. Thus, upon answering a question, the user may be presented with an option to return to the particular part of the lesson where the information from which the question was generated is presented. In addition, the user may be presented with information particularly tailored by the author to provide a review over the subject material covered by the question. In some cases, it might be helpful to compel the user to learn or review more information based on an evaluation of the user's answers. Furthermore, when the time taken to answer a question is considered, tests may be crafted to measure the rapidity with which a user may work through a given test. Thus, overall time on a test or set of questions from a test may be measured, evaluated, and used to adapt the test to a particular user.

Questions may also be divided into groups that illustrate their relationship to the overall subject matter contained in the lesson. For example, questions that pertain to the same idea or same concept may be grouped into a question set. Feedback may then be given either on individual questions or on the entire question set or on both. Question sets may contain measures of difficulty, measures of time, measures of a passing or failing score, descriptive feedback, and prescriptive feedback.

As another example, question sets that are all related by a major concept or topic, may be grouped into a question set on collection. The material presented in a question set collection may be taken from the material presented to the user or may be new material that has not been presented to the user. Use of information not previously presented to the user is particularly useful when testing mastery of a concept. A question set collection may also contain a measure of the difficulty of the collection, a measure of time needed to complete the question set collection, a measure of a passing or failing score, descriptive feedback, and prescriptive feedback.

Grouping question set collections into a question series may indicate questions that relate to a series of major topics. A question series is designed to test over a plurality of major topics. A question series may also contain a measure of difficulty, a measure of time needed to complete the series, a measure of a passing or failing score, descriptive feedback, and prescriptive feedback.

Feedback, whether descriptive or prescriptive, may be given at any point along the way. For example, feedback may be given after each question, or feedback may be held until the completion of a group of questions. For example, feedback associated with a question set may be held until the question set is complete. Feedback associated with a question set collection or a question series may also be held until the question set collection or question series is complete.

Finally, questions may be asked in an exam mode. In one embodiment, the exam mode asks each question once without feedback. In another embodiment, each question is asked and feedback is provided. The exam mode may contain such items as measures of difficulty for the questions asked, a measure of the time needed to complete the exam, measure of passing or failing score, descriptive feedback and prescriptive feedback.

In addition, questions asked either in an exam mode or due to another trigger such as a study button, may be used to modify the subsequent questions asked. In other words, evaluation of the questions answered thus far may be used to modify subsequent questions asked. For example, if the user answers a given number of questions of difficulty level one without mistakes, the system may begin asking questions of difficulty level two. As another example, if the system determines through an evaluation mechanism that the user either has clearly mastered or clearly not mastered the material, an action may be performed. Such an action might be to terminate asking questions or to begin presenting material. If the user has not mastered the material, the presented material may be reviewed. If the user has mastered the material, it may be new material a user has not yet seen.

In an alternative embodiment, the system may be implemented as a computer program product for use with a computer system. Such implementation may include a series of computer instructions fixed either on a tangible medium, such as computer readable media (disk e.g., diskette, CD-ROM disk or other nonvolatile storage utilized in the computer system on which the present invention is embodied) or transmittable to a computer system via a modem or other interface device, such as a network or Internet connection. The transmission of computer readable media may also provide for the invention to be embodied in propagated signals that are readable and executable by the targeted computer system. The series of computer instructions embody all or part of the functionality previously described herein with respect to the system. Those skilled in the art should appreciate that such computer instructions may be written in a number of programming languages for use with many computer architectures or operating systems. Furthermore, such instructions may be stored in any memory device, such as semi-conductor, magnetic, optical or other memory devices, and may be transmitted using any communications technology, such as optical, infrared, microwave, or other transmission technologies that are capable of transmitting a propagated signal wave. It is expected that such a computer program product may be distributed as a removable media with accompanying printed or electronic documentation (e.g., shrink wrapped software) preloaded with a computer system (e.g., on system ROM or fixed disk) or distributed from a server or electronic bulletin board over the network in a form of a propagated signal (e.g., the Internet or Worldwide Web).

Thus, as discussed herein, the embodiments of the present invention embrace systems and methods for creating and using a cognitive index, selectively providing objects from the index, and organizing information to generate questions contextually relevant to the information associated with the index. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A system for utilizing a cognitive index in organizing data relationships, the system comprising:
a source content that includes one or more nodes;
a first computer system that includes a computer readable medium for storing information, and wherein the first computer system includes a mechanism that extracts one or more anchors from the source content;
a second computer device;
a network, wherein the first computer system and second computer device are connected to the network; and
an index, wherein at least a portion of the index is configured to be stored on the computer readable medium of the first computer device, and wherein a relationship of the one or more anchors is preserved in the index.

2. A system as recited in claim 1, wherein the first computer device is a plurality of computer devices.

3. A system as recited in claim 1, wherein the first computer system is a single computer device.

4. A system as recited in claim 1, wherein the source content includes text that is preserved on a computer readable medium.

5. A system as recited in claim 1, wherein the source content includes HTML code.

6. A system as recited in claim 1, wherein the first computer system automatically locates the one or more nodes in the source content and utilizes the one or more nodes to establish one or more corresponding conceptual nodes.

7. A system as recited in claim 6, further comprising a mechanism connected to the first computer system that allows a user to create additional nodes that are preserved in the index.

8. A system as recited in claim 1, wherein the network comprises a local area network.

9. A system as recited in claim 1, wherein the network comprises the Internet, the first computer system comprises a server, and the first computer device comprises a client.

10. A system as recited in claim 9, wherein the index is accessible by the second computer device through the use of a web page.

11. In a system that includes a computer device, a method for creating and using a cognitive index, the method comprising the steps for:
providing a source content;
establishing a first node associated with the source content;
establishing a second node associated with the source content;
selectively establishing one or more relationships between the first and second nodes;
selectively providing one or more expressions that connect the first and second nodes;
selectively preserving the first node, the second node, the one or more relationships, and the one or more expressions in an index; and
selectively providing information from the index.

12. A method as recited in claim 11, further comprising the step for selectively associating one or more objects to at least one of:
(i) the first node; and
(ii) the second node.

13. A method as recited in claim 12, wherein the one or more objects comprise at least one of:
(i) text;
(ii) graphics;
(iii) an audio file; and
(iv) a video file.

14. A method as recited in claim 13, wherein the step for selectively providing information comprises the steps for:
receiving a request that identifies one or more of the objects; and
providing the one or more identified objects.

15. A method as recited in claim 14, wherein step for providing the one or more identified objects comprises sending the one or more identified objects via email.

16. A method as recited in claim 11, wherein at least one of (i) the step for establishing the first node and (2) the step for establishing the second node is performed automatically.

17. A method as recited in claim 11, wherein the step for establishing the first node comprises the steps for:
locating an anchor in the source content; and
converting the anchor into a conceptual node.

18. A method as recited in claim 17, wherein the step for establishing the second node comprises the steps for:
establishing the second node as an associated node corresponding to the first node.

19. A method as recited in claim 11, wherein at least one of (i) the step for selectively providing one or more expressions that connect the first and second nodes, and (ii) the step for selectively preserving the first node, the second node, the one or more relationships, and the one or more expressions in an index comprise the step for providing questions to elicit answers.

20. A computer program product for implementing within a computer system a method for a method for creating and using a cognitive index, the computer program product comprising:
computer readable medium for providing computer program code means utilized to implement the method, wherein the computer program code means is comprised of executable code for implementing the steps for:
providing a source content;
establishing a first node associated with the source content;
establishing a second node associated with the source content;
selectively establishing one or more relationships between the first and second nodes;
selectively providing one or more expressions that connect the first and second nodes;
selectively preserving the first node, the second node, the one or more relationships, and the one or more expressions in an index; and
selectively providing information from the index.
